(19) United States
(12) Patent Application Publication
(10) Pub. No.: US 2026/0184004 A1
(43) Pub. Date: Jul. 2, 2026

(54) Method for sterilising the blowing network of a machine for forming thermoplastic containers

(71) Applicant: SIDEL PARTICIPATIONS, OCTEVILLE-SUR-MER (FR)

(72) Inventors: Jérémy MARIE, OCTEVILLE-SUR-MER (FR); Sandy LETELLIER, OCTEVILLE-SUR-MER (FR); Grégory TOUTAIN, OCTEVILLE-SUR-MER (FR)

(21) Appl. No.: 18/037,975

(22) PCT Filed: Nov. 24, 2021
(86) PCT No.: PCT/EP2021/082863

§ 371 Date: Sep. 25, 2025

(30) Foreign Application Priority Data
Nov. 26, 2020 (FR) 2012172

(51) Int. Cl. B29C 49/42; B29C 49/78

(52) U.S. Cl. CPC B29C 49/42405; B29C 49/786

(57) ABSTRACT

Described are forming machines for forming containers from preforms and methods of sterilizing. The machine has a blowing network having ducts that connect a controlled source of compressed blowing gas to a blowing nozzle and a sterilizing device. The device has a controlled source of a pressurized hot drying gas connected to the blowing network at a supply junction, a controlled source of sterilizing vapor, and a chamber for mixing the sterilizing vapor with the drying gas to form a sterilizing gaseous mixture. The method includes heating the ducts of the blowing network by injection of the pressurized hot drying gas, then injecting the sterilizing gaseous mixture into the blowing network. Injecting is initiated when the coldest point of the blowing network reaches a treatment temperature higher than both a condensation temperature of the vapor at the cold point, and lower than the hot drying gas at the supply junction.

The invention relates to a method for sterilizing a forming machine for forming containers from preforms made of thermoplastic material, the forming machine comprising a blowing network which comprises ducts which connect a controlled source of compressed blowing gas to at least one blowing nozzle for forming the containers by blowing, the forming machine comprising a device for sterilizing the blowing network comprising:
a controlled source of a pressurized hot drying gas, distinct from the controlled source of blowing gas, which is connected to the blowing network at a supply junction;
a controlled source of sterilizing vapor comprising a vaporized oxidizing agent;
a chamber for mixing the sterilizing vapor with the drying gas to form a sterilizing gaseous mixture comprising vaporized oxidizing agent and water vapor;
the method comprising:
a step of heating of the ducts of the blowing network by injection only of the pressurized hot drying gas, during which the drying gas heats up the internal walls of the ducts of the blowing network;
a second step of injection of the sterilizing gaseous mixture into the blowing network.

### TECHNICAL BACKGROUND

To do this, an installation for manufacturing containers comprises at least one oven for heating the preforms which is associated with a forming machine (also called “blowing machine”) for the molding of the containers from said hot preforms. The installation also advantageously comprises a sterilization unit for sterilizing at least the inside of the preforms so as to obtain so-called “sterile” containers.

To perform the molding by blowing or by stretching-blowing of a hot preform, in one or more steps, it is known practice to use, for the blowing, at least one fluid, generally a gas, such as compressed air at pressures with values of up to 30 or 40 bar depending on the applications. To make it possible to distribute the material more uniformly in the final container, there is sometimes a preliminary pre-blowing operation which consists in injecting a blowing fluid at lower pressure, for example at 13 bar, into the preform before proceeding with the actual blowing operation by means of a blowing gas at high pressure as explained previously.

The air used for the blowing is introduced into the hot preform placed in a mold such that the blowing air enters directly into contact with the internal surface of the container. To this end, the forming machine comprises a controlled source of blowing air which supplies several blowing nozzles via blowing ducts.

Now, the internal surface is itself intended to be subsequently in contact with the product which will be packaged in the container.

The quality of the blowing air, more particularly the absence of contaminants, such as microorganisms, particles such as dust, etc., is therefore an important parameter to be taken into account in the overall control of the risks of contamination of the containers manufactured and particularly in order to be able to guarantee, notably in the case of food industry packaging, a good conservation of the packaged product, notably a conservation time, and safety of the consumer.

Now, the quality of the compressed air used for the blowing is determined by a set of factors, from the quality of the atmospheric air sucked in which varies according to the environment of the industrial site and its location with respect to polluting sources to the state of the distribution network and/or of the installation.

The atmospheric air sucked in and compressed by at least one compressor for example exhibits a greater or lesser degree of relative humidity and the humidity promotes corrosion and the development of microorganisms.

Particular attention is also paid to the choice of the compressors, the compressors being by their design, more particularly the lubrication means, likely to generate a chemical contamination of the air for example by lubrication oil or even Teflon dust.

This is why the compressed air intended to be used for the blowing is treated beforehand and more particularly filtered by gas filtration means in order to obtain a blowing air which is “sterile”, that is to say in particular free of microorganisms.

The compressed air used for the blowing is generally successively filtered by a filtration system comprising different gas filtration means.

In a nonlimiting manner, such a system for filtration of air intended for the blowing comprises, for example, multiple filtration means which, arranged in series, are intended to deliver at the output a sterile air.

The air therein is for example successively filtered by first filtration means of “FFP” type to obtain in particular a deoiling, a water purification and an elimination of dust, then second filtration means of “AK” (active carbon) type to remove all the oil and gaseous hydrocarbon vapors that can also cause a smell or taste nuisance, and finally by third filtration means of “SRF” type to retain the microorganisms.

Indeed, the blowing air is likely to be a vector of contamination of the inside of the preform, and therefore of the container, by introducing therein contaminants and more particularly microorganisms (viruses, germs, spores, etc.).

The control of the quality of the compressed air used for the blowing is even more important when, in the container manufacturing method, the filling of the containers is performed in an aseptic environment directly after the molding of the container obtained by blowing or by stretching-blowing of a hot preform.

Indeed, in such a manufacturing method, the sterilization is generally performed upstream on the preforms, prior to their transformation into containers, such that it is then essential to prevent the risks of contamination of the sterilized preforms, like that of the containers manufactured from these preforms.

The invention aims to sterilize the blowing ducts which are arranged downstream of the filtration means and which conduct the sterile blowing air to the blowing nozzles. This notably makes it possible to guarantee that the air remains sterile until it reaches the preforms.

The sterilization of the blowing ducts must make it possible to destroy the microorganisms present in order to prevent the development thereof in the blowing ducts and thus eliminate the risks of contamination of the preforms.

In the case of an industrial application like that of the manufacturing of containers intended for the packaging of food industrial products, it is important to be able to guarantee a quality, and more particularly the sterility, of the blowing air.

To sterilize the blowing ducts, it is known practice to circulate a sterilizing gaseous mixture comprising an oxidizing agent in gaseous phase in the blowing ducts. The oxidizing agent in the vapor phase is generally formed by the evaporation of the oxidizing agent in liquid phase, for example hydrogen peroxide (H2O2).

Such a sterilizing gaseous mixture presents the drawback of condensing on the internal walls of the blowing ducts. The contact with the oxidizing agent in the vapor phase makes it possible to eliminate the microorganisms without damaging the blowing ducts. However, given the strong oxidizing power of the oxidizing agent, the condensation droplets comprising oxidizing agent rapidly damage the internal walls of the ducts by corrosion.

To resolve this problem, it is known practice to produce the blowing ducts in a stainless steel material. However, such a material is very costly and that very substantially increases the cost of manufacturing of the forming machine.

The invention therefore proposes a solution which makes it possible to avoid the appearance of condensation of the oxidizing agent during the sterilization operation. That would notably make it possible to be able to use a less costly metallic material for the manufacturing of the blowing ducts.

### SUMMARY OF THE INVENTION

The invention relates to a method for sterilizing a forming machine for the forming of containers from preforms made of thermoplastic material, the forming machine comprising a blowing network which comprises ducts which connect a controlled source of compressed blowing gas to at least one blowing nozzle for forming the containers by blowing, the forming machine comprising a device for sterilizing the blowing network comprising:
a controlled source of a pressurized hot drying gas, distinct from the controlled source of blowing gas, which is connected to the blowing network at a supply junction;
a controlled source of sterilizing vapor comprising a vaporized oxidizing agent;
a chamber for mixing the sterilizing vapor with the drying gas to form a sterilizing gaseous mixture comprising vaporized oxidizing agent and water vapor;
the method comprising:
a step of heating of the ducts of the blowing network by injection only of the pressurized hot drying gas, during which the drying gas heats up the internal walls of the ducts of the blowing network;
a second step of injection of the sterilizing gaseous mixture into the blowing network,
characterized in that the second step of injection of the sterilizing gaseous mixture is initiated when the coldest point, called cold point, of the blowing network exposed to the sterilizing gaseous mixture reaches a treatment temperature which is higher than a condensation temperature of the water vapor and of the vaporized sterilizing agent at said cold point, the treatment temperature being lower than the temperature of the hot drying gas taken at the supply junction.

According to another feature of the method carried out according to the teachings of the invention, the treatment temperature is determined in such a way that the ratio, called relative saturation, of the partial pressure of the mixture of water vapor and of vaporized sterilizing agent to the saturating vapor pressure of said mixture at the cold point of the blowing network lies within a determined range extending between 70% and 90%.

According to another feature of the method carried out according to the teachings of the invention, the determined range extends between 80% and 90%.

According to another feature of the method carried out according to the teachings of the invention, the treatment temperature is measured by means of a probe arranged at the cold point.

According to another feature of the method carried out according to the teachings of the invention, the relative saturation is measured at the cold point of the blowing network by means of a sensor.

According to another feature of the method carried out according to the teachings of the invention, the temperature, the humidity and the pressure of the drying gas at the supply junction are constant.

According to another feature of the method carried out according to the teachings of the invention, the controlled source of drying gas is controlled with constant flow rate for the entire duration of the sterilization method.

According to a first embodiment of the method carried out according to the teachings of the invention, the controlled source of sterilizing vapor is controlled with a constant flow rate during the second step of injection of the sterilizing gaseous mixture of the sterilization method.

According to a second embodiment of the method carried out according to the teachings of the invention, the controlled source of sterilizing vapor has a flow rate that can occupy at least one intermediate flow rate between a zero flow rate and a maximum flow rate throughout the sterilization method.

According to another feature of the method carried out according to the teachings of the invention, the flow rate of sterilizing vapor in the mixing chamber is controlled according to the measurement made by the sensor to keep the relative saturation within the determined range at the cold point.

The invention relates also to a forming machine for implementing the method carried out according to the teachings of the invention, the forming machine comprising a blowing network which comprises ducts which connect a controlled source of compressed blowing gas to at least one blowing nozzle for forming the containers by blowing, the forming machine comprising a device for sterilizing the blowing network comprising:
a controlled source of a pressurized hot drying gas, distinct from the controlled source of blowing gas, which is connected to the blowing network at a supply junction;
a controlled source of sterilizing vapor comprising a vaporized oxidizing agent;
a chamber for mixing the sterilizing vapor with the drying gas to form a sterilizing gaseous mixture comprising vaporized oxidizing agent and water vapor;
characterized in that it comprises a temperature probe arranged so as to measure the temperature of a duct of the blowing network in the nozzle or in proximity to the nozzle.

### BRIEF DESCRIPTION OF THE FIGURES

Other features and advantages of the invention will become apparent on reading the following detailed description, for an understanding of which reference will be made to the attached drawings in which:

FIG. 1 is a pneumatic diagram which represents a forming machine for implementing the method carried out according to the teachings of the invention.

FIG. 2 is a pneumatic diagram which represents in more detail one of the molding stations with which the forming machine of FIG. 1 is equipped.

FIG. 3 is a pneumatic diagram which represents in more detail a sterilizing device with which the forming machine of FIG. 1 is equipped.

FIG. 4 is a block diagram which represents a sterilization method carried out according to a first embodiment of the invention which implements the forming machine represented in FIG. 1.

FIG. 5 is a diagram which represents the temperature in the blowing network of the forming machine of FIG. 1 as a function of the length of ducts traveled toward the nozzles from a supply junction point with the sterilization device.

FIG. 6 is a diagram which represents the trend of the relative saturation of the gas present in a cold point of the blowing network of the forming machine of FIG. 1 as a function of time during implementation of the method represented in FIG. 4.

FIG. 7 is a block diagram which represents a sterilization method carried out according to a second embodiment of the invention which implements the forming machine represented in FIG. 1.

### DETAILED DESCRIPTION OF THE INVENTION

Hereinafter in the description, elements which have an identical structure or similar functions will be designated by the same reference.

Hereinafter in the description, the terms “upstream” and “downstream” are used to describe the direction of flow of a gas in ducts.

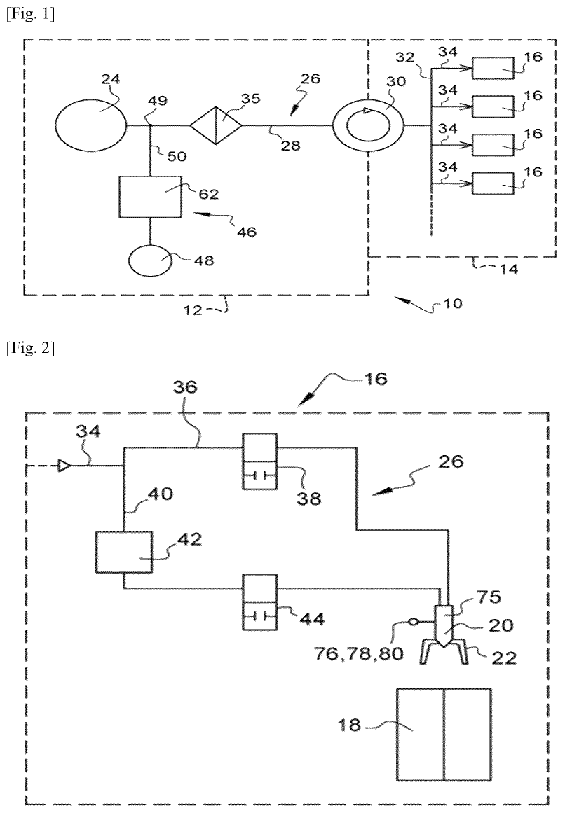

FIG. 1 represents a pneumatic diagram illustrating an exemplary embodiment of a machine 10 for forming containers by blowing or stretching-blowing of preforms made of thermoplastic material.

The forming machine 10 has a part 12 which is fixed with respect to the ground and a revolving part 14 which is mounted on a revolving carousel (not represented).

The revolving part 14 comprises several molding stations 16 which are mounted on the carousel. This disposition makes it possible to produce containers in large numbers. As represented in FIG. 2, each molding station 16 comprises a mold 18 which is intended to receive a preform and which has a die of the container to be produced. Each molding station 16 also comprises a blowing nozzle 20 which is conformed so as to blow a pressurized forming gas into the preform received in the mold 18. It is for example a nozzle 20 which comprises a dome-shaped end-fitting 22 which is intended to cap a neck of the preform received in the mold 18.

The fixed part 12 comprises a controlled source 24 of compressed blowing gas. The blowing gas is for example compressed to approximately 40 bar. The blowing gas is for example air.

The controlled source 24 of blowing gas is connected to the nozzles 20 of each molding station 16 by a network of blowing ducts, called blowing network 26 hereinafter in the description and in the claims. The ducts of the blowing network 26 are, here, produced in a material which is likely to be oxidized rapidly in contact with an oxidizing agent in liquid form, such as hydrogen peroxide or acetic acid, unlike ducts produced in stainless material.

More particularly, the blowing network 26 comprises a main supply duct 28 which connects the controlled source 24 of blowing gas to a revolving joint 30 which makes it possible to form the interface between the fixed part 12 and the revolving part 14. The blowing network 26 also comprises at least one distribution ramp 32 which belongs to the revolving part 14 and which is connected to the main supply duct 28 via the revolving joint 30. The distribution ramp 32 is connected to each of the molding stations 16 by means of associated distribution ducts 34.

To guarantee the quality of the blowing air, a filtration member 35, for example a filter of “SRF” type, is inserted into the main supply duct 28.

As represented in FIG. 2, in each of the molding stations 16, the blowing network 26 also comprises a high-pressure blowing duct 36 which is connected to the distribution duct 34 associated with the nozzle 20. A two-way blowing valve 38 is inserted into the high-pressure blowing duct 36. The blowing valve 38 is controlled alternatively between an open position and a closed position.

In each of the molding stations 16, the blowing network 26 also comprises a low-pressure pre-blowing duct 40 which connects the distribution duct 34 associated with the nozzle 20 in parallel with the high-pressure blowing duct 36. The low-pressure blowing duct 40 comprises a blowing gas pressure regulation member 42 in order to lower the pressure, for example to approximately 13 bar. A two-way pre-blowing valve 44 is inserted into the low-pressure blowing duct 40. The pre-blowing valve 44 is controlled alternately between an open position and a closed position.

The forming machine 10 also comprises a device 46 for sterilizing the blowing network 26. The sterilization device 46 comprises a controlled source 48 of a pressurized hot drying gas, for example air. The controlled source 48 of drying gas is distinct from the controlled source 24 of blowing gas. The controlled source 48 of drying gas is connected to the blowing network 26 at a supply junction 49 via a sterilization duct 50.

The controlled source 48 of drying gas is, here, arranged on the fixed part 12 of the forming machine 10. The supply junction 49 is preferably also arranged on the fixed part 12 of the forming machine 10, upstream of the revolving joint 30. The supply junction 49 is, here, arranged in the main blowing duct 28. The supply junction 49 is more particularly arranged upstream of the filtration member 35.

In a variant of the invention that is not represented, the supply junction is arranged downstream but in proximity to the filtration member. In this case, it is preferable to provide additional sterilization means for the sterilization member.

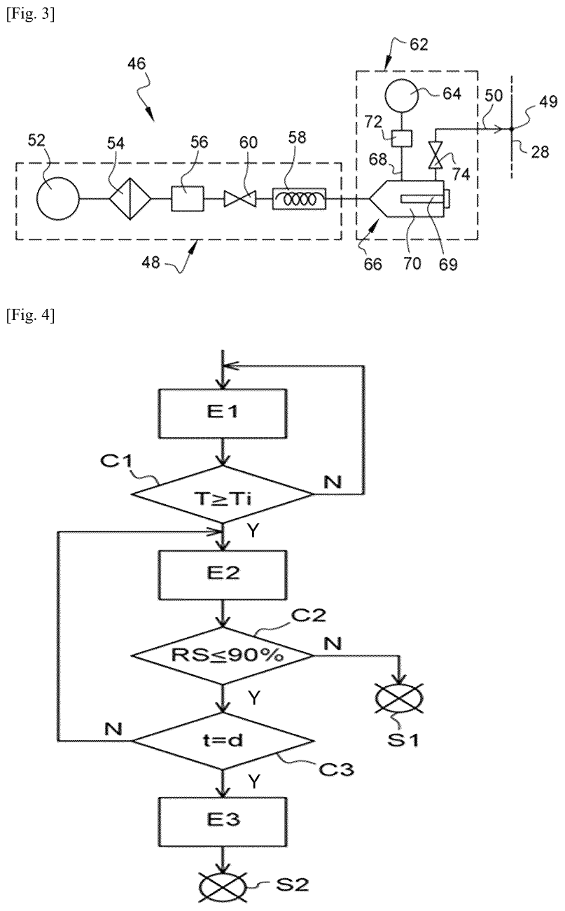

The sterilization device 46 is represented in more detail in FIG. 3. The controlled source 48 of drying gas comprises a source 52 of pressurized gas, for example air, which supplies the sterilization duct 50. The controlled source 48 of drying gas further comprises a filter 54 for guaranteeing that the drying gas does not include any impurity, a pressure regulation member 56, and a member 58 for heating the drying gas to a determined temperature. The temperature “Tg” of the hot drying gas is for example approximately 180° C. The controlled source 48 of drying gas further comprises a valve 60 for regulating the flow rate of drying gas. The regulation valve 60 is, here, controlled into a closed position in which the flow rate of drying gas is zero or into an open position in which the drying gas is delivered with a constant flow rate.

The sterilization device 46 also comprises a controlled source 62 of sterilizing vapor. As represented in FIG. 3, it comprises a tank 64 of sterilizing liquid comprising an oxidizing agent. The oxidizing agent is for example hydrogen peroxide (H2O2) or peracetic acid. The sterilizing liquid is for example formed from an aqueous solution comprising a determined concentration of oxidizing agent, for example a solution of hydrogen peroxide diluted to 25% in water.

The controlled source 62 of sterilizing vapor also comprises an evaporator 66 in which sterilizing vapor is produced by total evaporation of the sterilizing liquid supplied by the tank 64 of sterilizing liquid via an injection duct 68. The evaporator 66 comprises a member 69 heating to a temperature that is sufficient to allow the instantaneous evaporation of the sterilizing liquid.

The heating member 69 is arranged in a chamber of the evaporator 66. The sterilizing vapor thus comprises vaporized oxidizing agent and water vapor in well defined proportions.

The controlled source 62 of sterilizing vapor further comprises a device 72 for distributing sterilizing liquid which is inserted between the tank 64 of sterilizing liquid and the evaporator 66. Here, it is a distribution device 72 with adjustable flow rate.

The chamber of the evaporator 66 here forms a chamber 70 for mixing sterilizing vapor with the drying gas to form a sterilizing gaseous mixture exhibiting a partial sterilizing vapor pressure that is determined as a function of the mass flow rate of drying gas and of the mass flow rate of sterilizing vapor. To this end, the mixing chamber 70 is inserted into the sterilizing duct 50.

Since the mixing chamber 70 is, here, formed directly by the chamber of the evaporator 66, the mass flow rate of sterilizing vapor is understood to be the mass of sterilizing vapor produced by evaporation in the evaporator 66 per unit of time.

In a variant that is not represented, the mixing chamber is distinct from the chamber of the evaporator. The mixing chamber is then arranged downstream of the evaporator in the direction of flow of the sterilizing vapor.

The sterilization device 46 also comprises a flow rate regulation valve 74 which is inserted into the sterilization duct 50 downstream of the mixing chamber 70. The regulation valve 74 is, here, controlled either into a closed position in which it prohibits the passage of any gas to the blowing network 26, or into an open position.

The forming machine 10 can operate according to a mode of production in which the sterilization device 46 is controlled so as to send neither sterilizing vapor nor drying gas into the blowing network 26. In production mode, the controlled source 24 of blowing gas is controlled so as to inject blowing gas into the blowing network 26. The blowing valve 38 and the pre-blowing valve 44 of each molding station 16 are controlled according to the position of said molding station 16 with respect to the fixed part 12 to blow in by turns blowing gas at low pressure then blowing gas at high pressure to allow the forming of the container from a preform.

The forming machine 10 is also capable of operating according to a sterilization mode which can be implemented only when the production mode is deactivated. The sterilization mode is, for example, activated upon a change of container format and/or even at regular time intervals to avoid the development of germs in the blowing network 26. Generally, the sterilization mode is advantageously activated before the forming machine 10 is ever set to production mode. When the sterilization mode is implemented, the mold is empty, that is to say it does not include any preform.

When operating in sterilization mode, the forming machine 10 implements a sterilization method which is represented in FIG. 4.

Hereinbelow, a condensation temperature “Td” of a mixture of water vapor and of vaporized sterilizing agent, for determined respective molar concentrations and for a determined total pressure of the sterilizing gaseous mixture, is defined as being the temperature below which the water vapor and/or the vaporized sterilizing agent begins to condense. The condensation temperature “Td” is for example determined by phase diagrams or charts which indicate the condensation temperature “Td” as a function of pressure and/or as a function of the molar concentration of vaporized sterilizing agent in the sterilizing gaseous mixture. This parameter is generally given by the supplier of sterilizing agent on delivery of the product. This parameter can also be found or easily deduced from works that are well known to the person skilled in the art such as “Hydrogen Peroxide” by Schumb et al., dating from 1955.

The partial pressure of vaporized sterilizing agent in the sterilizing gaseous mixture is also defined as being the pressure that said vaporized sterilizing agent alone would have. This partial pressure depends notably on the ambient temperature and on the molar concentration of vaporized sterilizing agent present in the sterilizing gaseous mixture.

Likewise, the partial pressure of water vapor in the sterilizing gaseous mixture is also defined as being the pressure that the water vapor alone would have. This partial pressure depends notably on the ambient temperature and on the molar concentration of water vapor present in the sterilizing gaseous mixture.

The molar concentration can be defined from the concentration by weight or from the concentration by volume of sterilizing agent. Thus, knowing the mass flow rate of sterilizing vapor and the mass flow rate of drying gas, it is possible to know the molar concentration of sterilizing agent in the vapor state contained in the sterilizing gaseous mixture.

The saturating vapor pressure is also defined as being the partial pressure of a gaseous component in a sterilizing gaseous mixture from which said component begins to condense. The saturating vapor pressure increases with ambient temperature.

Thus, in a hot atmosphere, the sterilizing gaseous mixture will be able to contain a greater concentration of said gaseous component before reaching the saturating vapor pressure compared to a colder atmosphere, in the same pressure conditions.

The relative saturation “RS” of the sterilizing gaseous mixture is defined as being the ratio between the sum of the partial pressures of sterilizing agent in the vapor state and of water vapor with respect to the saturating vapor pressure of the water vapor and of the vaporized oxidizing agent of the sterilizing gaseous mixture. The relative saturation “RS” is here expressed as a percentage, the temperature conditions being determined. Thus, as long as the relative saturation “RS” is lower than 100%, no condensation occurs in the sterilizing gaseous mixture. When the relative saturation “RS” reaches 100%, the water and/or the oxidizing agent begin to condense. The relative saturation “RS” of the mixture of vaporized sterilizing agent and of water vapor is for example determined by phase diagrams or charts which indicate the relative saturation “RS” as a function of pressure and/or as a function of ambient temperature and/or as a function of the molar concentration of vaporized sterilizing agent in the sterilizing gaseous mixture.

Finally, the relative humidity of the drying gas is defined as being the partial pressure of water vapor over the saturating vapor pressure of the water vapor of the drying gas.

In the method carried out according to the teachings of the invention, some parameters are constant throughout the sterilization method, such as the temperature “Tg”, the relative humidity and the pressure of the drying gas at the supply junction 49. The flow rate of the controlled source 48 of drying gas is also constant in all the steps of the sterilization method.

Prior to commencement of the sterilization method, a sterilizing vapor flow rate setpoint is determined so as to guarantee a satisfactory sterilization of the blowing network 26.

The flow rate setpoint is for example approximately 0.19 kg/h for a forming machine 10 comprising six stations or even approximately 1.9 kg/h for a forming machine 10 comprising thirty stations. This setpoint is for example a function of the length of the blowing network 26. A time “d” of exposure of the blowing network 26 to the sterilizing gaseous mixture is also determined.

The time of the sterilization method is for example approximately 30 minutes, each of the three steps, as described hereinbelow, lasting approximately 10 minutes.

According to a first embodiment of the sterilization method, the sterilizing vapor flow rate setpoint and the time “d” of exposure are, here, set beforehand. They are for example constant values which are determined by experimentation or by computation according to characteristics of the forming machine 10, such as the number of molding stations 16.

The method according to the invention on the other hand proposes acting on the temperature of the blowing network 26 to avoid the condensation of the sterilizing vapor in the ducts of the blowing network 26.

To allow the sterilization of all of the ducts of the blowing network 26, provision is made to open the blowing valves 38 and the pre-blowing valves 44 for the entire duration of the sterilization method as is represented in FIG. 2. The controlled source 24 of blowing gas is controlled into closed position for the entire duration of the sterilization method.

The method comprises a first step “E1” of heating of the ducts of the blowing network 26. In this first step “E1”, only the pressurized hot drying gas is injected into the blowing network 26, with the determined flow rate. The drying gas thus heats up each duct of the blowing network 26 at least to a treatment temperature “Ti” by flowing in a single direction from the supply junction 49 to the nozzle 20.

The method also comprises a second step “E2” of injection of the sterilizing gaseous mixture into the blowing ducts, which is triggered at the end of the first, heating step “E1”. The device 72 for distributing the sterilizing liquid is controlled to inject the sterilizing liquid with a flow rate corresponding to the sterilizing vapor flow rate setpoint. During this step “E2” of injection of the sterilizing gaseous mixture, the vaporized oxidizing agent present in the sterilizing gaseous mixture sterilizes the ducts of the blowing network 26 by direct contact. The sterilizing gaseous mixture flows in a single direction from the supply junction 49 to the nozzle 20. A sterilizing gaseous mixture suction duct (not represented) is provided, arranged downstream of the nozzle 20 or connected to the nozzle in proximity to the end-fitting 22 or even at the mold, to allow the sterilizing gaseous mixture including the sterilizing agent to be evacuated after its passage through the blowing network 26.

Finally, a third and last step “E3” of aeration is triggered when the time “d” of exposure is reached, as indicated by the condition “C3”. The device 72 for distributing the sterilizing liquid is then closed to stop the production of sterilizing vapor.

The flow rate of drying gas on the other hand is maintained. The drying gas therefore continues to circulate, alone, in the ducts of the blowing network 26 for the time it takes to evacuate the residues of sterilizing vapor. The method is then terminated, as indicated by the reference “S2”.

The purpose of the first, heating step “E1” is to heat up the ducts of the blowing network 26, that is to say the internal walls forming said ducts, to a treatment temperature “Ti” higher than the condensation temperature “Td” to guarantee the sterilizing vapor will not condense on contact with the ducts of the blowing network 26.

The second step “E2” of injection of the sterilizing gaseous mixture is triggered before all the ducts of the blowing network 26 are heated up uniformly. Because it is not uniformly heated up at the start of the method, the blowing network 26 therefore has a section of duct, called “cold point 75”, which is colder than the rest of the ducts of the blowing network 26. The second step “E2” of injection of the sterilizing gaseous mixture is more particularly triggered when the cold point 75 of the blowing network 26 exposed to the sterilizing gaseous mixture reaches the treatment temperature “Ti”, the treatment temperature “Ti” being lower than the temperature “Tg” of the hot drying gas, taken at the supply junction 49.

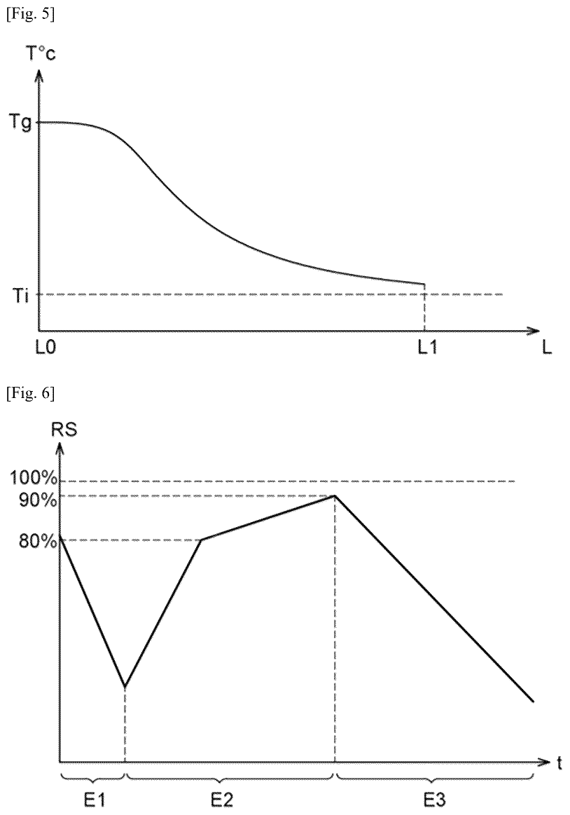

This cold point 75 is generally situated in the nozzle 20 or in proximity to the nozzle 20, for example directly upstream of the nozzle 20, or downstream of the nozzle 20 in the mold 18. In fact, the ducts of the blowing network 26 are at a cold temperature relative to the treatment temperature “Ti” at the start of the method. In its flow in the ducts of the blowing network 26, the hot drying gas initially, as a priority, exchanges calories with the ducts of the blowing network 26 situated in proximity to the supply junction 49, such that, as is indicated in FIG. 5, it establishes a temperature gradient that decreases as a function of the length “L” of ducts traveled from upstream to downstream in the blowing network 26 from the supply junction 49, indicated by the point “L0”, to the nozzles 20, indicated by the point “L1”.

Thus, when the cold point 75 reaches the treatment temperature “Ti”, the blowing network 26 is not heated uniformly, but according to a gradient that decreases with the length “L” traveled from upstream to downstream from the supply junction 49. Thus, the second step “E2” of injection of the sterilizing gaseous mixture is initiated before the blowing network 26 is heated up to a uniform temperature. That makes it possible to more rapidly trigger the second step “E2” of injection of the sterilizing gaseous mixture, and thus reduce the total time of the method and the energy consumed by the method.

The treatment temperature “Ti” is higher than the condensation temperature “Td” of the water vapor and of the vaporized sterilizing agent at said cold point 75 to avoid any condensation of the vaporized oxidizing agent and/or of the water vapor.

To determine that the cold point 75 has reached the treatment temperature “Ti”, provision is for example made to arrange a temperature probe 76 at the cold point 75. This probe 76 measures the trend of the temperature during the first, heating step “E1”, and when the measured temperature condition “C1” is equal to the treatment temperature “Ti”, the second step “E2” of injection of the sterilizing gaseous mixture is initiated.

In a variant of the invention that is not represented, the time needed to reach the treatment temperature “Ti” at the coldest point is determined experimentally. The second step “E2” of injection of the sterilizing gaseous mixture is then initiated at the end of this time.

Obviously, along the step “E2” of injection of the sterilizing gaseous mixture, the temperature of the cold point 75 will continue to increase beyond the treatment temperature “Ti” under the effect of the passage of the sterilizing gaseous mixture which exhibits substantially the same temperature “Tg” as the drying gas. Thus, the saturating vapor pressure of the mixture of vaporized sterilizing agent and of water vapor increases also. This guarantees that no condensation will occur during this second step “E2” of injection of the sterilizing gaseous mixture.

The first, heating step “E1” further makes it possible to lower the relative humidity in the ducts of the blowing network 26. Condensed water would in fact be likely to hamper the efficiency of the sterilization method and degrade the ducts of the blowing network 26. According to a variant of the invention that is not represented, the relative humidity of the gas present in the ducts of the blowing network 26 is for example measured by means of a relative humidity sensor 78 to guarantee that the ducts of the blowing network 26 are sufficiently dry to initiate the second step “E2” of injection of the sterilizing gaseous mixture, notably when the relative humidity is lower than a threshold value, of 40% for example. The relative humidity is, here, measured at the cold point 75 of the blowing ducts. Thus, in the sterilizing gaseous mixture at the cold point 75, the quantity of water vapor comprises not only the quantity of water vapor which was present in the sterilizing vapor, but also the quantity of water vapor already present in the duct.

The treatment temperature “Ti” is determined in such a way that the relative saturation “RS” at the cold point 75 of the blowing network 26 lies within a determined range extending between 70% and 90%, preferably between 80% and 90%.

The upper limit of this range makes it possible to reserve a margin of error to guarantee that no condensation will occur in the ducts of the blowing network 26.

The lower limit of this range makes it possible to obtain two advantages. That first of all makes it possible to start up the step “E2” of injection of the sterilizing gaseous mixture more rapidly. Furthermore, it has been found that the sterilization operation was much more effective when said ratio “RS” was high.

The relative saturation “RS” is, here, measured at the cold point 75 of the blowing ducts by means of a relative saturation “RS” sensor 80. It is for example one and the same device which fulfils the role of relative saturation “RS” sensor 80, of relative humidity sensor 78 and of temperature probe 76. Said device is for example formed by a probe sold under the brand name “PEROXCAP” by the company Vaisala under the reference “HPP272”. Such a device makes it possible to easily take account of the presence of residual water vapor in the blowing network 26 at the end of the first, heating step “E1”.

“FIG. 6” shows a diagram which represents the trend of the relative saturation “RS” as a function of time at the cold point 75 during the method.

In the first, heating step “E1”, the relative saturation “RS” corresponds in fact to the relative humidity “RH” because the blowing network 26 does not yet include vaporized sterilizing agent, only water vapor. The relative saturation “RS” drops regularly under the effect of the increase in temperature of the cold point 75 provoked by the passage of the drying gas. When the treatment temperature “Ti” is reached, the relative saturation “RS” is lower than the determined threshold value.

In the second step “E2” of injection of the sterilizing gaseous mixture, the relative saturation “RS” increases regularly to reach the determined range. It is maintained within the determined range by maintaining the flow of sterilizing gaseous mixture in the blowing network 26 until the end of the second step “E2” of injection of the sterilizing gaseous mixture.

Finally, in the third step “E3” of aeration, the relative saturation “RS” drops once again progressively under the effect of the pure drying gas which drives the sterilizing gaseous mixture out of the blowing network 26.

A condition “C2” of the relative saturation “RS” is regularly tested during the second step “E2” of injection of the sterilizing gaseous mixture. When the sensor 78 measures a relative saturation “RS” higher than 90%, it sends a signal to an electronic control unit (not represented) which commands the closure of the sterilizing liquid distribution device 72 and/or the closure of the regulation valve 74 to prevent the arrival of sterilizing vapor in the blowing network 26 and thus prevent any condensation, as indicated by the reference “S1”.

The controlled source 62 of sterilizing vapor is controlled with a constant flow rate in the second step “E2” of injection of the sterilizing gaseous mixture of the sterilization method. A distribution device which would produce a pulsed flow rate, such as a peristaltic pump, is not considered, in the sense of the invention, as a device capable of producing a vapor flow rate that is constant in the sense of the invention.

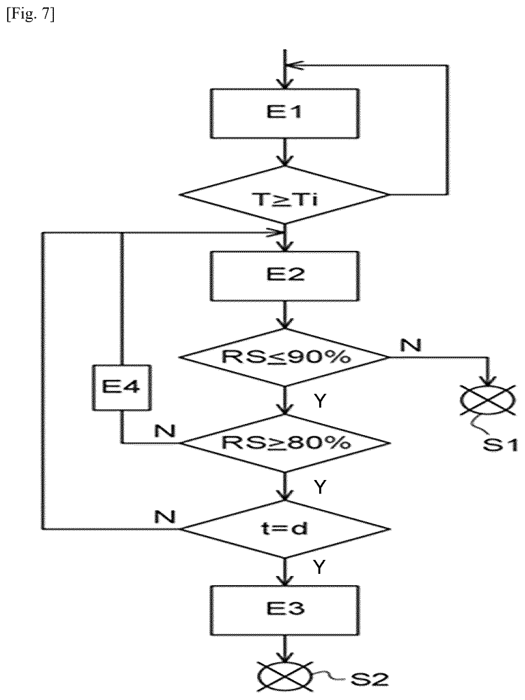

According to a second embodiment of the sterilization method which is represented in FIG. 7, the controlled source 62 of sterilizing vapor has a flow rate that can occupy at least one intermediate flow rate between a zero flow rate and a maximum flow rate throughout the sterilization method.

The flow rate can, for example, vary continually. In this case, the distribution device 72 is formed by a valve with adjustable flow rate.

In a variant that is not represented, the flow rate can vary discretely. The distribution device 72 is, for example, formed by several ducts of different passage sections which are arranged in parallel between the tank 64 of sterilizing liquid and the evaporator 66. A common, multiple-way distribution valve which makes it possible to direct the liquid to one or another of said ducts to vary the flow rate.

In this embodiment, the saturating vapor flow rate in the mixing chamber 70 is controlled as a function of the measurement made by the sensor 78 to maintain the partial saturating vapor pressure as close as possible to the upper limit of the determined range at the cold point 75. For example, when the relative saturation “RS” drops below a lower limit, for example 80%, the flow rate of sterilizing vapor is increased in an adjustment operation “E4”.

The sterilization method carried out according to the teachings of the invention is rapid and it safeguards the ducts of the blowing network 26 from corrosion. These objectives are achieved simultaneously by starting the second step “E2” of injection of the sterilizing gaseous mixture before all of the blowing network 26 is heated up uniformly while guaranteeing a sufficient temperature to avoid the condensation of the vaporized oxidizing agent.

The method is also very efficient. This efficiency is guaranteed by maintaining a fairly high relative saturation “RS” throughout the second step “E2” of injection of the sterilizing gaseous mixture.

1. A method for sterilizing a forming machine for forming containers from preforms made of thermoplastic material, the forming machine comprising a blowing network that comprises ducts which connect a controlled source of compressed blowing gas to at least one blowing nozzle for forming the containers by blowing, the forming machine comprising a device for sterilizing the blowing network comprising:
a controlled source of a pressurized hot drying gas, distinct from the controlled source of blowing gas, which is connected to the blowing network at a supply junction;
a controlled source of sterilizing vapor comprising a vaporized oxidizing agent; and
a chamber for mixing the sterilizing vapor with the drying gas to form a sterilizing gaseous mixture comprising vaporized oxidizing agent and water vapor;
the method comprising:
a step of heating of the ducts of the blowing network by injection only of the pressurized hot drying gas, during which the drying gas heats up internal walls of the ducts of the blowing network; and
a second step of injection of the sterilizing gaseous mixture into the blowing network,
wherein the second step comprises a step of measurement of a treatment temperature via a probe arranged at a coldest point of the blowing network exposed to the sterilizing gaseous mixture and in that the second step of injection of the sterilizing gaseous mixture is initiated when the coldest point reaches a treatment temperature that is higher than a condensation temperature of the water vapor and of the vaporized sterilizing agent at said coldest point, the treatment temperature being lower than the temperature of the hot drying gas taken at the supply junction.

2. The method as claimed in claim 1, wherein the treatment temperature is determined such that a relative saturation between a partial pressure of the mixture of water vapor and of vaporized sterilizing agent and a saturating vapor pressure of said mixture at the coldest point of the blowing network lies within a determined range extending between 70% and 90%.

3. The method as claimed in claim 2, wherein the determined range extends between 80% and 90%.

4. The method as claimed in claim 1, wherein the relative saturation is measured at the coldest point of the blowing network using a sensor.

5. The method as claimed in claim 1, wherein a temperature a humidity and a pressure of the drying gas at the supply junction are constant.

6. The method as claimed in claim 1, wherein the controlled source of drying gas is controlled with constant flow rate for an entire duration of the sterilization method.

7. The method as claimed in claim 1, wherein the controlled source of sterilizing vapor is controlled with a constant flow rate during the second step of injection of the sterilizing gaseous mixture of the sterilization method.

8. The method as claimed in claim 1, wherein the controlled source of sterilizing vapor has a flow rate capable of occupying at least one intermediate flow rate between a zero flow rate and a maximum flow rate throughout the sterilization method.

9. The method as claimed in claim 8, wherein the flow rate of sterilizing vapor in the mixing chamber is controlled according to the measurement performed by the sensor to keep the relative saturation within a determined range at the coldest point.

10. A forming machine for sterilizing a forming machine for forming containers from preforms made of thermoplastic material, the forming machine comprising a blowing network which comprises ducts that connect a controlled source of compressed blowing gas to at least one blowing nozzle for forming the containers by blowing, the forming machine comprising a device for sterilizing the blowing network comprising:
a controlled source of a pressurized hot drying gas, distinct from the controlled source of blowing gas, which is connected to the blowing network at a supply junction;
a controlled source of sterilizing vapor comprising a vaporized oxidizing agent; and
a chamber for mixing the sterilizing vapor with the drying gas to form a sterilizing gaseous mixture comprising vaporized oxidizing agent and water vapor;
wherein the forming machine comprises a temperature probe arranged at the coldest point of the blowing network exposed to the sterilizing gaseous mixture so as to measure the temperature of a duct of the blowing network in the nozzle or in proximity to the nozzle.
